(19) United States
(12) Patent Application Publication
(10) Pub. No.: US 2007/0003820 A1
(43) Pub. Date: Jan. 4, 2007

(54) Direct methanol fuel cell with 3-D anode

(76) Inventor: Alexander Kraytsberg, Katzrin (IL)

Correspondence Address: NATH & ASSOCIATES, 112 South West Street, Alexandria, VA, 22314, US

(21) Appl. No.: 11/151,535

(22) Filed: Jun. 14, 2005

Related U.S. Application Data
(60) Provisional application No. 60/579,603, filed on Jun. 15, 2004.

(51) Int. Cl. H01M 4/86; H01M 8/10

(52) U.S. Cl. 429/44; 429/30

(57) ABSTRACT

Described is a direct oxidation liquid feed fuel cell having a PEM sandwiched between a cathode and an anode. The anode includes a reticulated structure having more than one path made of interconnected pores connecting each point on one face of the reticulate structure to points of its other side. In a preferred embodiment the anode fills at least part of the fuel tank.

This patent application derives priority from provisional patent application No. 60/579,603, incorporated herein by reference.

### FIELD OF THE INVENTION

The invention relates to direct methanol fuel cells and to electrodes thereof.

### BACKGROUND OF THE INVENTION

As portable consumer electronics become increasingly important, there is a strong demand for portable power sources with high energy density and with the total power between several tenth of watt to a few watts. Up until now these demands are mostly met by different types of batteries. As a rule, these batteries are expensive, have a short operation life and also have disposal problems. Even the most advanced lithium ion batteries are not able to meet the energy demands of modern sophisticated color displays, wireless access to the Internet, multiplayer games on cell—phones and tablet computers for note-taking, which all demand more power than earlier generations of electronic devices did. For these new products, consumers want power sources that last days or weeks instead of hours.

Fuel cells that use hydrogen or methanol as fuel have considerable advantages over batteries. Pure hydrogen has theoretical energy capacity of 32.8 kWh/kg. and methanol has energy capacity of 5.8 kWh/kg. In comparison, Li—ion system, which is currently in use, has theoretical capacity of about 0.09 kW/kg.

Hydrogen solid polymer electrolyte fuel cells (PEM FC) are compact and have a high power performance, which fits the requirements of modem portable electronics. Nevertheless there is a problem with PEM FC application in portable electronics field. Considering particular portable fuel cell applications, not only weight power density but also volume energy density is a very important parameter. Being a gaseous matter, hydrogen has a very low theoretical volume energy density, about 0.0029 kWh/1. That's why it is necessary to use some means to compact the gas.

From the other side, methanol has a very high volume energy density, 4.72 kW/1. Methanol is easy to obtain, store and transport. It is easily available and inexpensive compound.

Nevertheless there is an unsolved problem with DMFC in portable electronics applications. The problem is that currently DMFCs have low specific power. One way to increase DMFC specific power is to develop a better anode catalyst. Up to now this way demonstrates only a limited success. The first relatively efficient catalyst for methanol oxidation (Pt—Ru catalyst) was introduced 30 years ago (see, for example, U.S. Pat. No. 4039409); from that time a big deal of improvements were made in a field of DMFC anode catalyst structure and in methods of the catalyst integration into DMFC anode. Only small—scale improvements were achieved to compare with “classic” Pt—Ru catalyst, whereas these improvements resulted in a substantial catalyst price increase.

### SUMMARY OF THE INVENTION

The invention provides, according to a first aspect thereof, a direct methanol fuel cell with a 3-D anode, which is fully or in part combined with a fuel reservoir.

The invention also provides liquid feed fuel cell with an anode comprising of reticulate body (also referred to herein as reticulated structure), which is electronically conductive and capable of catalyzing oxidation of said fuel.

The anode 3-D structure has catalyst disposed within the volume thereof. The catalyst is for catalyzing oxidation of the fuel, and it is preferably affixed to the inner surface (also referred to herein as inner walls) of the 3-D anode. A direct methanol fuel cell according to one embodiment of the invention operates without requiring forced air or forced methanol flow and near room temperature. According to another embodiment, the fuel cell of the invention works with forced methanol, forced air flow, and/or at elevated temperature.

In a preferred embodiment, the electrochemical fuel cell includes a solid polymer electrolyte membrane, sandwiched between a cathode and an anode. The anode includes a 3-D structure, which also houses the fuel.

According to one embodiment air or oxygen may be used as oxidizer, and the cathode includes gas diffusion layer, active catalyst layer and cathode current collecting layer. In other embodiments, fluid oxidizer, such as H₂O₂ may be used, and for this end, the cathode may have a different structure, which by itself is known in the art. According to one embodiment of the invention, the cathode also has 3-D electrode, with a structure similar to that of the 3-D anode, described in more details below.

The anode includes electronically conductive reticular foam, which internal surface has on it an oxidation catalyst, to allow the reticulated foam to serve as an anode. The foam serves also as a current collector.

In the present description and claims “reticulate structure” or “reticulate body” means a structure or body wherein there is more than one way to travel within interconnected pores between points on one face of the reticulate structure to points of its other side. The terms “pore” and “interconnected pores” as used herein cover also structures that are sometimes referred in the art as channels, bottle-necks, etc.

In a preferred embodiment, the solid polymer electrolyte membrane is placed in a housing. The housing walls contain a gas outlet. For instance, the walls may include a membrane that is permeable to gas that may be generated in the housing in a course of the fuel cell operation but not permeable to liquids.

The structure of the 3-D anode is reticular, and it has pores that are much larger (about 10 times or more) than the catalyst particles on the inner surface of the pores.

The anode structure should also be completely accessible for liquid fuel. That is to say that fuel travels freely from one side of the anode to the other. The pores are preferably spaced in such a way that they may all be reached from the outer surface of the anode, such that all parts of the inner anode surface is in contact with fuel, and fuel is not trapped inside the 3-D anode. The pores may be located in any manner: stochastic, ordered etc. The size of the pores should be large enough as to allow free fuel flow through the anode. The required flow rate is to be determined in accordance with the current that the fuel cell is required to produce, where larger current requires larger flow. Nevertheless, when catalyst particles of conventional size are used (about 5 μm), this requirement is redundant with the requirement from the pores to be much larger than the catalyst particles.

The preferred parameters of the 3-D anode are pore size of from about 100 μm to about 500 μm, preferably 200 μm; surface area of from about 30 to about 100 cm²/cm³, preferably from about 60 to about 80 cm²/cm³; specific weight of from about 0.03 to about 0.06 g/cm³ and porosity of from at least 50%, preferably from about 80% to about 97%.

A fuel cell of the invention is preferably fueled with methanol, or any other liquid fuel known in the art as suitable for fuel cells, such as those suggested in WO 01/5442. The oxidant is preferably oxygen or air, although a fuel cell according to the invention may also operate with condensed phase oxidants, such as hydrogen peroxide.

To evaluate power density of a fuel cell according to the invention, it may be assumed that a ¼ in. thick carbon foam sheet is used to design a 3-D anode, and that this material has 100 pores per linear inch with an internal area of 2000 square ft per cubic ft. In this case, the 3-D anode has an internal area of 42 cm² per each cm² of visible anode surface. Also it may be assumed that the current density on the internal surface of the 3-D anode is 8 mA/cm²; which is a current density, commonly achieved using “classic” DMFC anodes with commonly achieved overvoltage of about 0.25 V. The above-mentioned current density of 8 mA per sq. cm results in a current density of 42×8=336 mA per sq. cm of visible anode surface. Assuming DMFC over-voltage of 0.4 V for the entire cell, which is realistically low, this current gives specific power of about 130 mW/cm². This value is several times higher then specific power achieved with state of the art DMFC.

### BRIEF DESCRIPTION OF THE FIGURES

In order to understand the invention and to see how it may be carried out in practice, a detailed description of a preferred embodiment will now be given, by way of non-limiting example only, with reference to the accompanying drawings, in which:
FIG. 1 is a schematic illustration of a DMFC according to one embodiment of the invention;
FIG. 2 is a schematic illustration of a portion of a 3-D anode according to the invention; and
FIG. 3 is a schematic illustration of a DMFC according to another embodiment of the invention.

### DETAILED DESCRIPTION THE DRAWINGS

FIG. 1 shows schematically a liquid feed fuel cell 10 according to the invention. The DMFC 10 includes a cathode 12, a polymer electrolyte membrane (such as Nafion™) 14, and an anode 16, which is of a reticulated electronically conductive body with catalyst on its inner surface. The anode 16 completely fills a fuel tank 17. The cathode 12 and the anode 16 are each connected to its own current collectors 18 and 20, respectively.

FIG. 2 is a schematic illustration of a portion 16′ of the anode 16. The anode portion 16′ has a reticulate conductive body 22, defining pores 24. The inner surface of the pores 24 is covered with catalyst particles 26. The characteristic size of the pores 24 is much larger than the diameter of the particles 26. The anode portion 16′ is shown in FIG. 2 to be attached to a portion 14′ of the PEM 14 of FIG. 1.

The conductive body 24 may be made of a conductive substance, such as metal or carbon, or it may be made of an insulator, such as polyurethane foam, coated with an electronically conductive coating. Such conductive coating may be, for instance, conductive carbon black embedded in a binder.

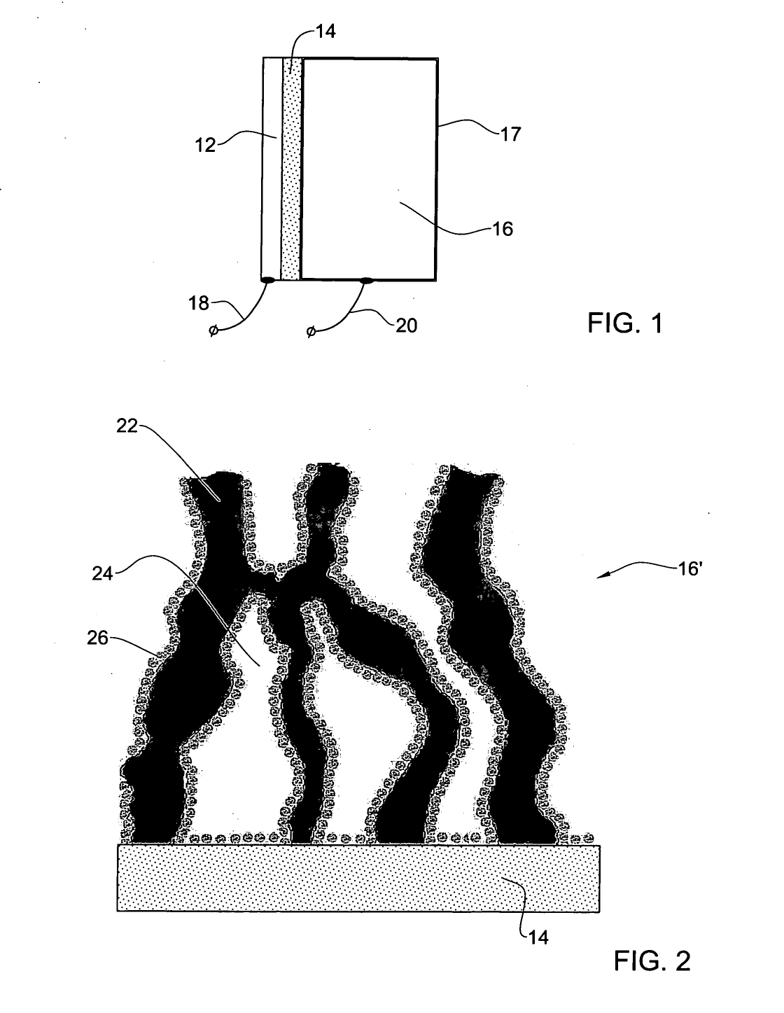

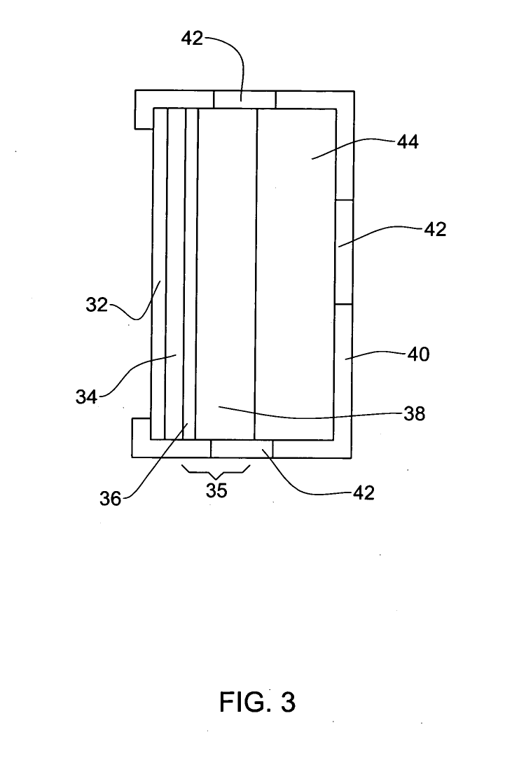

FIG. 3 is a schematic illustration of a DMFC 30 according to another embodiment of the present invention. The DMFC 30 includes an air-breathing cathode 32, a Nafion™ polymeric electrolyte membrane (PEM) 34, and an anode 35, which includes two parts: an on-membrane active layer 36, and a 3-D anode portion 38. The fuel cell 30 is inside a housing 40 having outlets for CO₂ in the form of gas permeable membranes 42. The DMFC 30 also includes a fuel tank 44, partly filled with the 3-D anode portion 38.

The on-membrane active layer 36 includes catalyst particles (not shown).

Preferable catalytic particles for use on the active layer 36 or on the surface of the 3-D anode portion 38 are made of high surface area carbon grains comprising small islands of catalytically active metals, metal alloys, or any other catalyst known in the art per se. Other preferred catalyst particles are unsupported particles of platinum black, other precious metal black, precious metal alloy black, or any other catalyst particles known in the art per se. The 3-D portion 38 of the anode is made of electronically conductive foam. Non-limiting examples of suitable foams are reticulated vitreous carbon foam; metal foam, and polymeric or ceramic foam, which surface is covered with flexible or inflexible conductive layer. A sufficient quantity of oxidation catalyst is to be presented on the conductive walls of the conductive foam. This may be accomplished by any suitable means, non-limiting examples of which are electro-deposition of catalytically active metals or alloys onto the foam's surface, and application of ink with catalyst particles to the anode internal surface. The 3-D anode portion 38 is affixed to the “on-membrane” anode active layer 36. The 3-D anode portion 38 function is both to support the catalyst and also to serve as a current collector; it also collects electrons from the “on-membrane” active layer 36.

The cathode 32 is built as known-in the art air-breathing cathode. The Cathode 32 and the anode 36 are both in contact with the PEM 34. Thus, the DMFC 30 employs a membrane electrode assembly (MEA) comprising a solid ionomer or ion-exchange membrane disposed between two electrodes.

In operation, the oxygen (or air) moves through the porous cathode current collector and GDL (gas diffusion layer) and is reduced at the cathode electro-catalyst layer, according to the equation (I)
½O₂−2H⁺+2e⁻→H₂O (I)
At the anode, the fuel moves through the 3-D anode portion 38 and is oxidized on a catalyst, which is deposited on its walls, and also on the on-membrane active layer catalyst 36:
CH₃0H+H₂O→CO₂+6e⁻+6H⁺ (II)
The protons produced at the on-membrane active layer 36, travel through PEM 34 towards the cathode 32. The protons produced at the 3-D anode portion 38 travel through the fuel mixture (water mixed with fuel and mineral or organic acid), which fills the pores of the 3-D anode portion 38, then through the active layer 36 and the PEM 34, towards the cathode 32.

The electrodes are electrically coupled to each other through an external load to provide a path for electrons from the anode to the cathode. The invention is not restricted to implementation with the particular fuel (methanol). The cell may be successfully used with other organic fuels, particularly with other alcohols, and particularly with ethanol.

What is claimed is:

1. A direct methanol fuel cell (DMFC) with a 3-D anode, comprising a conductive reticulated body with catalyst particles on its inner surface.

2. A DMFC according to claim 2, wherein said 3-D anode also includes a non-reticulated conductive layer attached to a polymer electrolyte membrane (PEM).

3. A DMFC according to claim 1, wherein said 3-D anode is combined with a fuel reservoir.

4. A DMFC comprising a solid polymer electrolyte membrane (PEM), sandwiched between a cathode and an anode; said anode comprising a 3-D structure, which on operation also houses fuel.

5. A DMFC according to claim 1, wherein the conductive reticulated body has pores with size of from 100 μm to 500 μm.

6. A DMFC according to claim 1, wherein the 3-D anode has surface area of between 30 and 100 cm²/cm³.

7. A DMFC according to claim 1, wherein the 3-D anode has porosity of from 80% to 97%.

8. A liquid feed fuel cell comprising an anode with a reticulated body, which is electrically conductive and capable of catalyzing oxidation of said fuel.

9. A liquid feed fuel cell according to claim 8, having catalyst particles on its internal surface.

10. A liquid feed fuel cell according to claim 8, comprising a fuel tank, and said anode fills at least part of the fuel tank.

11. A liquid feed fuel cell according to claim 8, wherein said reticulated body has pores with catalyst particles on their inner surface, and the pores are at least ten times larger than said catalyst particles.

12. A liquid feed fuel cell according to claim 8, wherein said reticulate body is made of an insulator coated with a conductive coating.

13. A liquid feed fuel cell according to claim 12, wherein said conductive coating also includes catalyst particles.

14. A liquid feed fuel cell according to claim 8, wherein said reticulated body is at least 50% void.

15. A liquid feed fuel cell according to claim 8, wherein said reticulated body is completely accessible for fuel.

16. A direct oxidation liquid feed fuel cell having a PEM sandwiched between a cathode and an anode, and said anode includes a reticulated structure having more than one path made of interconnected pores connecting each point on one face of the reticulate structure to points of its other side.
